(19) United States
(12) Patent Application Publication
(10) Pub. No.: US 2007/0229041 A1
(43) Pub. Date: Oct. 4, 2007

(54) Excess Current Detecting Circuit and Power Supply Device Provided with it

(76) Inventors: Hirokazu Oki, Kyoto (JP); Yuzo Ide, Kyoto (JP)

Correspondence Address: FISH & RICHARDSON P.C., P.O. BOX 1022, MINNEAPOLIS, MN, 55440-1022, US

(21) Appl. No.: 11/597,012

(22) PCT Filed: May 17, 2005
(86) PCT No.: PCT/JP05/08967

§ 371 Date: Nov. 17, 2006

(30) Foreign Application Priority Data
May 18, 2004 (JP) 2004-147290

(51) Int. Cl. G05F 1/00

(52) U.S. Cl. 323/266

(57) ABSTRACT

An excess current detecting circuit detects an excess current status of a power MOS transistor, which outputs a current to a load from a drain electrode, and outputs the excess current detection signal. The excess current detecting circuit is provided with: a detection MOS transistor wherein a source electrode and a gate electrode are connected to a source electrode and a gate electrode of the power MOS transistor, respectively, a constant current circuit connected with a drain electrode of the detection MOS transistor for flowing a prescribed constant current to the detection MOS transistor, and a comparator for outputting the excess current detection signal based on the results of the comparison between a potential of the drain electrode of the power MOS transistor and a potential of the drain electrode of the detection MOS transistor.

### TECHNICAL FIELD

The present invention relates to an excess current detecting circuit used for a power supply device or the like, and more specifically to an excess current detecting circuit provided with a MOS transistor (insulated-gate type field-effect transistor) as a switching element for outputting a current to a load. The present invention also relates to a power supply device having this excess current detecting circuit.

### BACKGROUND ART

FIG. 5 shows a conventional excess current detecting circuit provided with a MOS transistor as a switching element. In the excess current detecting circuit in FIG. 5, a supply voltage 105 is supplied to a source electrode of a P-channel (P-type semiconductor) power MOS transistor 100, whose drain electrode is connected to one end of a load 103 via a detecting resistance 101. The other end of the load 103 is grounded.

The node between the drain electrode of the power MOS transistor 100 and the detecting resistance 101 is connected to a base electrode of a NPN type transistor 102, and the node between the detecting resistance 101 and the load 103 is connected to an emitter electrode of the transistor 102. The supply voltage 105 is connected to a collector electrode of the transistor 102 via a resistance 104. To a gate electrode of the power MOS transistor 100, a pulse voltage for on-off control of the power MOS transistor 100 is supplied from the outside.

When the power MOS transistor 100 is in an ON state, a current flows to the load 103 via the detecting resistance 101. When an excess current flows to the power MOS transistor 100 due to, for example, short circuit between the both terminals of the load 103 for some reason, the transistor 102 is turned on by voltage drop occurring between the both terminals of the detecting resistance 100. As a result, the potential of a collector electrode of the transistor 102 transits from a high voltage state (the same voltage state as that of the supply voltage 105) to a low voltage state. Then, this transition is provided as an excess current detection signal to a control part (not shown), which recognizes that the power MOS transistor is in the excess current state and thus cuts off the power MOS transistor 100.

There is another conventional configuration example as shown in FIG. 6 (for example, see Patent document 1). In an excess current detecting circuit in FIG. 6, a supply voltage 110 is supplied to a drain electrode of an N-channel (N-type semiconductor) power MOS transistor 112, whose source electrode is connected to one end of a load 116 whose the other end is grounded.

The supply voltage 110 is supplied to a drain electrode of an N-channel (N-type semiconductor) detection MOS transistor 111 whose source electrode is commonly connected to one end of a detecting resistance 114 and an non-inverting input terminal (+) of a comparator 115. The other end of the detecting resistance 114 is connected to a node between a source electrode of the power MOS transistor 112 and the load 116 and also to an inverting input terminal (−) of the comparator 115. Each gate electrode of the power MOS transistor 112 and the detection MOS transistor 111 is commonly connected to a terminal 113, to which a pulse voltage for on-off control of both the power MOS transistor 112 and the detection MOS transistor 111 is supplied from the outside.

Moreover, the power MOS transistor 112 has a large number of (k number where k is an integer of 2 or larger, for example, 100) unit cell transistors and formed as a single MOS transistor by respectively connecting together drains, sources, and gates of the large number of unit cell transistors in parallel. On the other hand, the detection MOS transistor 111 is formed of, for example, one same unit cell transistor. The channel area ratio of the power MOS transistor 112 and the detection MOS transistor 111 is 100 to 1, and thus the ratio of currents flowing to these transistors is also 100 to 1 (configuration example shown in FIG. 6 is hereinafter referred to as “Example 1 of patent document 1”).

In the excess current detecting circuit configured in this manner, when an excess current flows to the power MOS transistor 112 and one hundredth of this current flows to the detection MOS transistor, a voltage drop equal to or larger than the reference voltage defined inside the comparator 115 occurs across the detecting resistance 114. At this point, the comparator 115 outputs an excess current detection signal indicating an excess current is flowing through the power MOS transistor 112, notifying a control part, not shown, of the excess current state of the power MOS transistor 112.

The patent document 1 to be described below also discloses the following configuration example. A semiconductor device of this example has an output power MOS transistor and an excess current detecting circuit part formed within a single element. The output power MOS transistor has a large number of unit MOS transistor elements arranged side by side, and their sources, gates, and drains are respectively coupled together by conductors to serve as the source, gate, and drain of the output power MOS transistor, which is thus formed as a single element composed of the unit MOS transistor elements. The excess current detecting circuit part detects an excess current flowing through the output power MOS transistor by detecting a voltage drop across a routing resistance produced in the conductor of the source or the drain as a result of connecting together the sources or drains of the unit elements described above (hereinafter, this configuration example will be referred to as “Example 2 of patent document 1”).

[Patent Document 1] Register Utility Model No. 2525470 (Japan)

### DISCLOSURE OF THE INVENTION

### Problems to be Solved by the Invention

However, in the conventional configuration example shown in FIG. 5, the detecting resistance 101 is provided between the power MOS transistor 100 and the load 103 for the purpose of detecting an excess current state of the power MOS transistor 100, thus causing power loss in the detecting resistance 101, which results in deterioration in the power efficiency of the circuit as a whole and also larger heat generation problem.

Forming the detecting resistance 101 through, for example, diffusion of impurities on the semiconductor substrate results in large temperature dependence (for example, approximately 2000 ppm/C.°) of a resistance value thereof. That is, a temperature coefficient of the detecting resistance 101 is large. Thus, a threshold of a current for detecting an excess current state of the power MOS transistor 100 has large temperature dependence, thus resulting in a large detection error in excess current detection (hereinafter, may be indicated simply as “detection error”) (large temperature dependency of a detection error). A base-emitter voltage at which the transistor 102 turns on has large temperature dependence, thus also resulting in a large detection error.

In addition, heat generated at the detecting resistance 101 affect a resistance value of the detecting resistance 101 and the base-emitter voltage at which the transistor 102 turns on, thus resulting in an even larger detection error.

Also in Example 1 of patent document 1 shown in FIG. 6, as is the case with that in FIG. 5, a threshold of a current for detecting an excess current state has large temperature dependence due to large temperature dependence possessed by the detecting resistance 114, thus resulting in a large detection error (large temperature dependence of a detection error).

Even if the channel area ratio between the power MOS transistor 112 and the detection MOS transistor 111 is designed to be k to 1 (100 to 1) and the ratio of current flowing to these transistors is designed to be k to 1, due to the voltage drop occurring at the detecting resistance 114, a drain-source voltage of the detection MOS transistor 111 is smaller than a drain-source voltage of the power MOS transistor 112. Therefore, the on-resistance (drain-source resistance at which the transistor is on; a resistance of the channel) of the detection MOS transistor 111 becomes larger than an ideal value (ideally k times the on-resistance of the power MOS transistor 112), thus failing to obtain an actual current ratio as designed. That is, due to Early's effect, the actual current ratio is not as designed, which also results in a large detection error.

In addition, due to the voltage drop occurring at the detecting resistance 114, a gate-source voltage in the detection MOS transistor 111 is smaller than a gate-source voltage in the power MOS transistor 112, which also results in a larger on-resistance of the detection MOS transistor than an ideal value, thus leading to an even larger detection error.

Moreover, in Example 2 of patent document 1, a routing resistance of a source or a drain is used as a detecting resistance, but a resistance value which can be set by using the routing resistance is limited, thus losing a degree of freedom in designing.

In view of the problem described above, the present invention has been made, and it is an object of the invention to provide a high-accuracy excess current detecting circuit which is free from a detection error attributable to the Early's effect while maintaining high power efficiency of the entire circuit and also which has less temperature dependence of a detection error. It is also another object of the invention to provide a power supply device having this excess current detecting circuit.

### MEANS FOR SOLVING THE PROBLEM

To achieve the object described above, an excess current detecting circuit according to one aspect of the present invention detects an excess current state of an output transistor for outputting a current to a load and then outputs an excess current detection signal. The excess current detecting circuit includes: a detection transistor which is connected to the output transistor in parallel therewith; a constant current circuit which is connected to one end of the detection transistor and which feeds a predetermined constant current to the detection transistor; and a comparator which, based on a result of comparison of a voltage between a first and a second electrodes of the output transistor generated by feeding the current to the load and a voltage between a first and a second electrodes of the detection transistor generated by feeding the constant current, outputs the excess current detection signal.

According to this configuration, upon detecting the excess current state, the comparator compares a magnitude difference between the voltage between the first and second electrodes of the output transistor generated by feeding the current to the load and the voltage between the first and second electrodes of the detection transistor generated by feeding the constant current.

Thus, the period when a current flowing through the output transistor just reaches an excess current state after its increase corresponds to a period when the comparator judges that “the voltage generated between the first and second electrodes of the output transistor” and “the voltage generated between the first and second electrodes of the detection transistor” are equal. Thus, “deviation of an actual current ratio from a designed value attributable to Early's effect”, which is a problem in the conventional structure example as shown in FIG. 6, does not arise. That is, almost no detection error attributable to the Early's effect occurs, thus permitting excess current detection with high accuracy.

Moreover, a detecting resistance (detecting resistance 101 or the like) which has been essential for the detection of an excess current state in the conventional structure examples shown in FIGS. 5 and 6 (Example 1 of patent document 1) is not used in the configuration described above according to the invention, thus causing no large temperature dependency of a detection error attributable to a large temperature coefficient. That is, excess current detection can be achieved with small temperature dependency of a detection error (with a small increase in a detection error attributable to temperature change).

As described above, excess current detection with high accuracy and small temperature dependency can be achieved, thus permitting a maximum output current value of the output transistor (threshold for detecting an excess current state) to be closer to an ideal value. Consequently, this results in improving reliability of the excess current detecting circuit and a power supply device including this according to the invention, and the like, thus permitting achieving a reduction in the packaging surface area and also cost reduction.

Further, since no detecting resistance (detecting resistance 101 or the like) is provided between the output transistor and the load, the power efficiency is excellent, and heat generation due to the presence of detecting resistance can also be suppressed.

An excess current detecting circuit according to another aspect of the invention detects an excess current state of an output transistor for outputting a current to a load via a second electrode thereof and then outputs an excess current detection signal. The excess current detecting circuit includes: a detection transistor having a first and a control electrodes commonly connected to a first and a control electrodes, respectively, of the output transistor; a constant current circuit which is connected to a second electrode of the detection transistor and which feeds a predetermined constant current to the detection transistor; and a comparator which, based on a result of comparison of a potential of the second electrode of the output transistor and a potential of the second electrode of the detection transistor, outputs the excess current detection signal.

According to such configuration, upon detecting the excess current state, the comparator compares a magnitude difference between the potential of the second electrode of the output transistor and the potential of the second electrode of the detection transistor. Moreover, the first and control electrodes of the detection transistor are connected to the first and control electrodes of the output transistor, respectively.

Thus, the period when a current flowing through the output transistor just reaches an excess current state after its increase corresponds to a period when the comparator judges that “the voltage generated between the first and second electrodes of the output transistor” and “the voltage generated between the first and second electrodes of the detection transistor” are equal. Thus, “deviation of an actual current ratio from a designed value attributable to Early's effect”, which is a problem in the conventional structure example as shown in FIG. 6, does not arise. That is, almost no detection error attributable to the Early's effect occurs, thus permitting excess current detection with high accuracy.

Moreover, a detecting resistance (detecting resistance 101 or the like) which has been essential for the detection of an excess current state in the conventional structure examples shown in FIGS. 5 and 6 (Example 1 of patent document 1) is not used in the configuration described above according to the invention, thus causing no large temperature dependency of a detection error attributable to a large temperature coefficient. That is, excess current detection can be achieved with small temperature dependency of a detection error.

As described above, excess current detection with high accuracy and small temperature dependency can be achieved, thus permitting a maximum output current value of the output transistor (threshold for detecting an excess current state) to be closer to an ideal value. Consequently, this results in improving reliability of the excess current detecting circuit and a power supply device including this according to the invention, and the like, thus permitting achieving a reduction in the packaging surface area and also cost reduction.

Further, since no detecting resistance (detecting resistance 101 or the like) is provided between the output transistor and the load, the power efficiency is excellent, and heat generation due to the presence of detecting resistance can also be suppressed.

For example, in the configuration described above, the output transistor and the detection transistor may be a power MOS transistor and a detection MOS transistor, respectively, and a value of the constant current may be set based on a previously defined maximum output current value of the power MOS transistor, a value of on-resistance of the power MOS transistor, and a value of on-resistance of the detection MOS transistor.

Here, the “maximum output current value” is a threshold for detecting the excess current state of the power MOS transistor, and a value previously defined in accordance with a characteristics of the power MOS transistor. The excess current detecting circuit described above is designed so that, when the magnitude of the current flowing through the power MOS transistor is less than the maximum output current value, it is detected that “the power MOS transistor is not in an excess current state”, while, when the magnitude of the current flowing through the power MOS transistor exceeds the maximum output current value, it is detected that “the power MOS transistor is in an excess current state.

For example, in the configuration described above, the output transistor may be a power MOS transistor having n (where n is an integer of two or larger) number of unit cell transistors, and may be formed as a single MOS transistor by respectively connecting together drains, sources, and gates of the n-number of unit cell transistors in parallel; the detection transistor may be a detection MOS transistor which is formed of a single unit cell transistor or which has m (where m is an integer of two or larger which is smaller than n) number of unit cell transistors and is formed as a single MOS transistor by respectively connecting together drains, sources, and gates of the m-number of unit cell transistors in parallel; and the unit cell transistors forming the power MOS transistor and the unit cell transistor or transistors forming the detection MOS transistor may be all formed on a same semiconductor substrate by use of a same manufacturing process.

Consequently, temperature coefficients of the values of on-resistance of the power MOS transistor and the detection MOS transistor are substantially equal; thus, temperature dependency of a threshold of a current for detecting the excess current state is small (fluctuation of the threshold due to temperature change is small). That is, excess current detection with smaller temperature dependency of a detection error can be achieved. Moreover, an actual ratio of “the value of on-resistance of the detection MOS transistor” to “the value of on-resistance of the power MOS transistor” is substantially equal to a designed ratio, thus permitting excess current detection with high accuracy.

In the configuration described above, the constant current may be a current obtained by applying a predetermined reference voltage to combined resistance of resistance having a positive temperature coefficient and resistance having a negative temperature coefficient, and a value of the combined resistance may be adapted to be fixed without depending on temperature change.

Consequently, the value of the constant current becomes fixed without depending on temperature change, which permits even smaller temperature dependency of a detection error in excess current detection.

However, taking a manufacture error and the like into consideration, it is difficult to allow the value of the combined resistance not to fluctuate at all due to temperature change. Therefore, “fixed without depending on temperature change” here is a concept in a broad sense taking the manufacture error and the like into consideration.

A power supply device according to still another aspect of the invention includes: the excess current detecting circuit described above, the output transistor, and a smoothing circuit which smoothes an output side voltage of the output transistor and outputs the voltage to the load.

For example, the power supply device described above may further include a voltage detecting circuit which outputs a voltage in accordance with the voltage supplied to the load, and a control part which, in accordance with an output from the voltage detecting circuit, controls the output transistor and the detection transistor.

For example, the control part may be controlled in accordance with the output of the comparator.

### ADVANTAGES OF THE INVENTION

As described above, with the excess current detecting circuit according to the present invention, while high power efficiency of the entire circuit can be maintained, a detection error attributable to Early's effect can be eliminated and also temperature dependency of a detection error can be reduced.

### BRIEF DESCRIPTION OF DRAWINGS

FIG. 1 A circuit diagram of a power supply device including an excess current detecting circuit according to an embodiment of the present invention.

FIG. 2 A detailed circuit diagram of a power MOS transistor in FIG. 1.

FIG. 3 A detailed circuit diagram of a constant current circuit in FIG. 1.

FIG. 4 A detailed circuit diagram of a constant voltage generating circuit in FIG. 3.

FIG. 5 A circuit diagram showing a first example of a conventional excess current detecting circuit.

FIG. 6 A circuit diagram showing a second example of a conventional excess current detecting circuit.

### LIST OF REFERENCE SYMBOLS

1 Power supply device
2, 100, 112 Power MOS transistor (output transistor)
3, 111 Detection MOS transistor (detection transistor)
4 24 Constant current circuit
5 Comparator
6, 103, 116 Load
7 Control part
8, 9, 21, 22, 36, 37, 104 Resistance
10 Diode
11 Inductor
12 Capacitor
14 Excess current detecting circuit
15 Drain electrode
16 Source electrode
17 Gate electrode
20, 23, 31, 32, 33, 34, 35, 102 Transistor
101, 114 Detecting resistance
115 Comparator
Vcc Supply voltage
25 Constant voltage generating circuit
Vref Reference voltage
Ic Constant current
Tr1, Tr2, . . . , Trn Unit cell transistor

### BEST MODE FOR CARRYING OUT THE INVENTION

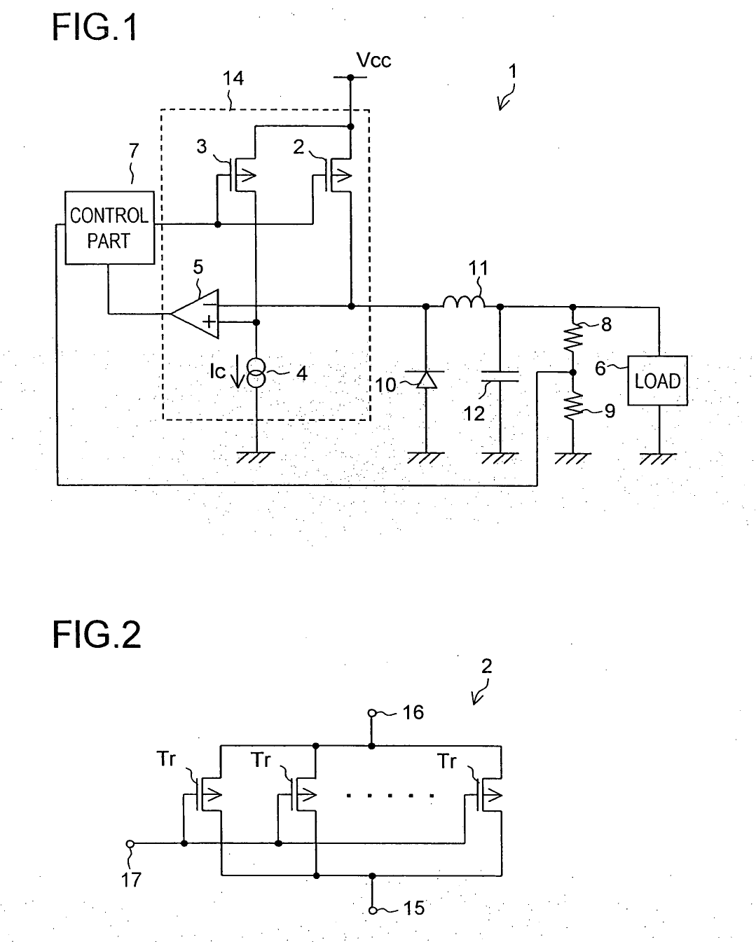

Hereinafter, an embodiment of an excess current detecting circuit according to the present invention will be described, with reference to the accompanying drawings. FIG. 1 is a circuit configuration diagram of a power supply device 1 including an excess current detecting circuit 14 according to the embodiment of the invention. FIG. 2 is a detailed circuit configuration diagram of a power MOS transistor 2 in FIG. 1.

In the power supply device 1, a supply voltage Vcc is supplied to a source electrode of a P channel (P-type semiconductor) power MOS transistor 2 (output transistor). A drain electrode of the P channel power MOS transistor 2 is connected to a cathode of a diode 10 having anode thereof grounded and is also connected to one end of an inductor 11. The other end of the inductor 11 is grounded via a parallel circuit of a load 6 and a capacitor 12 and also via a series circuit of resistances 8 and 9. The power MOS transistor 2 outputs a current (supplies a power) to the load 6 from a drain electrode, and the diode 10, the inductor 11, and the capacitor 12 form a smoothing circuit which smoothes a voltage on the output side of the power MOS transistor 2 (voltage of the drain electrode) and outputs it to the load 6.

The supply voltage Vcc is also supplied to a source electrode of a P-channel detection MOS transistor (detection transistor) 3, whose drain electrode is connected to one end of a constant current circuit 4 and a non-inverting input terminal (+) of a comparator 5. The other end of the constant current circuit 4 is grounded, and the constant current circuit 4 feeds a constant current Ic between the source and drain electrodes of the detection MOS transistor 3 when the detection MOS transistor 3 is on.

A node between the power MOS transistor 2 and the cathode of the diode 10 is connected to the inverting input terminal (−) of the comparator 5. A node between the resistances 8 and 9 is connected to the control part 7. A voltage supplied to the load 6 is divided by the series circuit of the resistances 8 and 9, and the divided voltage value is provided to the control part 7. That is, the resistances 8 and 9 function as voltage detecting circuits for outputting, to the control part 7, a voltage in accordance with a voltage supplied to the load 6.

An output of the comparator 5 is provided as an excess current detection signal, which indicates an excess current state of the power MOS transistor 2, to the control part 7. More specifically, when a voltage outputted by the comparator 5 is a high signal (high potential signal), this indicates that the power MOS transistor 2 is in an excess current state, and when the aforementioned voltage is a low signal (low potential signal), this indicates that the power MOS transistor 2 is in a normal state (not in an excess current state).

That is, the comparator 5 compares the potential of the drain electrode of the power MOS transistor 2 and the potential of the drain electrode of the detection MOS transistor 3 and outputs a result of this comparison as an excess current detection signal. Here, “excess current state” means a state in which a value of a drain current of the power MOS transistor 2 exceeds the maximum output current value of the power MOS transistor 2. The term “maximum output current value” is a threshold for detecting an excess current state of the power MOS transistor 2 and a value previously defined in accordance with characteristics of the power MOS transistor 2. The excess current detecting circuit 14 is designed so that it is detected that “the power MOS transistor 2 is not in an excess current state” when a magnitude of the drain current flowing through the power MOS transistor 2 is less than the maximum output current value, while it is detected that “the power MOS transistor 2 is in an excess current state” when the magnitude of the drain current flowing through the power MOS transistor 2 exceeds the maximum output current value.

The excess current detecting circuit 14 is formed of the detection MOS transistor 3, the constant current circuit 4, and the comparator 5, but the power MOS transistor 2 may also be considered to be included in the excess current detecting circuit 14. A description below is based on the assumption that the power MOS transistor 2 is included in the excess current detecting circuit 14.

An output of the control part 7 is commonly connected to gate electrodes of the power MOS transistor 2 and the detection MOS transistor 3. The control part 7, while monitoring the excess current state of the power MOS transistor 2 by referring to an excess current detection signal, detects a voltage added to the load 6 based on a potential at the midpoint between the resistances 8 and 9, and supplies a voltage in a pulse form to each gate electrode of the power MOS transistor 2 and the detection MOS transistor 3 so that the voltage applied to the load 6 becomes constant.

The series circuit of the resistances 8 and 9 is provided for detecting a voltage added to the load 6, and their combined resistance value is sufficiently larger than the resistance value (or impedance) of the load 6 (thus, power loss in this series circuit is ignorably small).

The power MOS transistor 2, as shown in the FIG. 2, is so formed as to have a large number of (n-number where n is an integer of 2 or more) unit cell transistors (this unit cell transistor is also an insulated-gate type field-effect transistor) Tr1, Tr2, . . . , and Trn. The power MOS transistor 2 is formed as a single MOS transistor by respectively connecting together drains, sources, and gates of the unit cell transistors in parallel. That is, electrodes formed by respectively connecting together the drain electrodes, source electrodes, and gate electrodes of the n number of unit cell transistors Tr1, Tr2, . . . , and Trn in parallel are provided as a drain electrode 15, a source electrode 16, and a gate electrode 17 of the power MOS transistor 2.

On the other hand, the detection MOS transistor 3 is formed of only a single unit cell transistor. The detection MOS transistor 3, as is the case with the power MOS transistor 2, may also be so formed as to have a plurality (m number where m is an integer of 2 or larger and is smaller than n) unit cell transistors (not shown), and may be formed as a single MOS transistor by respectively connecting together drains, sources, and gates of the unit cell transistors in parallel. That is, drains electrodes, source electrodes, and gate electrodes of the m number of unit cell transistors are respectively parallelly connected together are provided as a drain electrode, a source electrode, and a gate electrode of the detection MOS transistor 3, respectively.

The unit cell transistors forming the power MOS transistor 2 and the unit cell transistor or transistors forming the detection MOS transistor 3 are all formed on the same semiconductor substrate in the same manufacturing processes. That is, all the unit cell transistors have the same structure, and thus have substantially the same temperature coefficient of an on-resistance value; thus, under the same condition for a voltage between the gate and source electrodes, a voltage between the drain and source electrodes, and an ambient temperature (this condition is hereinafter referred to as “the same condition”), the on-resistance values are substantially the same.

Hereinafter, a description will be given, referring to a case, for example, where the power MOS transistor 2 is formed of 1000 unit cell transistors connected together in parallel and the detection MOS transistor 3 formed of a single unit cell transistor. In this condition, the channel area ratio between the power MOS transistor 2 and the detection MOS transistor 3 is 1000 to 1, and thus the ratio of on-resistance values is 1 to 1000.

Specifically, assume that the maximum output current value of the power MOS transistor 2 is Ioₘₐₓ. That is, if the drain current of the power MOS transistor 2 exceeds Ioₘₐₓ, the comparator 5 judges that the power MOS transistor 2 is in an excess current state and outputs a high signal to the control part 7.

Further, assume that, between the maximum output current value loₘₐₓ and a constant current Ic in the constant current circuit 4, relationship Ic=Ioₘₐₓ/1000 is established. That is, the value of the constant current Ic is set based on the maximum output current value Ioₘₐₓ, the on-resistance value of the detection MOS transistor 3, and the on-resistance value of the power MOS transistor 2. More specifically, a value obtained by dividing the maximum output current value Ioₘₐₓ by the ratio of “the on-resistance value of the detection MOS transistor 3” to “the on-resistance value of the power MOS transistor 2” (1000) under the same condition is set as a value of the constant current Ic.

(Description of Excess Current Detection Operation)

Next, the excess current detection operation performed in the power supply device 1 will be described. If a current flowing through the power MOS transistor 2 is smaller than the maximum output current value Ioₘₐₓ when the power MOS transistor 2 is on, a voltage between the drain and source electrodes of the power MOS transistor 2 is smaller than a voltage between the drain and source electrodes of the detection MOS transistor 3, and thus the comparator 5 outputs a low signal.

Then, if the current flowing through the power MOS transistor 2 exceeds the maximum output current value Ioₘₐₓ, due to abnormality, such as short between the both terminals of the load 6, the voltage between the drain and source electrodes of the power MOS transistor 2 becomes larger than the voltage between the drain and source electrodes of the detection MOS transistor 3, and thus the comparator 5 outputs a high signal.

Upon receiving the high signal from the comparator 5, the control part 7 recognizes that the power MOS transistor 2 is in an excess current state, and provides a voltage for turning off the power MOS transistor 2 to the gate electrode of the power MOS transistor 2, thereby preventing breakage and the like of the power MOS transistor 2, the diode 10, the inductor 11, and the load 6. Once the control part 7 detects the excess current state of the power MOS transistor 2, the power MOS transistor 2 is kept off unless a cancellation signal is inputted from the outside or a supply voltage Vcc is reintroduced (unless the supply of the supply voltage Vcc is once cut off and the power is turned on again).

In the event of short between the both terminals of the load 6 or the like, a current much larger than the maximum output current value Ioₘₐₓ flows through the power MOS transistor 2, and thus some detection error is not a problem. This detection error (detection accuracy) becomes a problem when the drain current of the power MOS transistor 2 is nearly the maximum output current value Ioₘₐₓ (for example, 100% to 120% of Io).

Now, in the excess current detecting circuit 14, the voltage between the gate and source electrodes of the power MOS transistor 2 and the voltage between the gate and source electrodes of the detection MOS transistor 3 are equal. When the drain current of the power MOS transistor 2 is equal to the maximum output current value Ioₘₐₓ, the potentials of the non-inverted input terminal (+) and the inverted input terminal (−) of the comparator 5 are equal because the voltage between the drain and source electrodes of the power MOS transistor 2 and the voltage between the drain and source electrodes of the detection MOS transistor 3 are equal.

At this point, the ratio of on-resistance resistance values between the power MOS transistor 2 and the detection MOS transistor 3 is exactly 1 to 1000 (since an error due to the Early's effect can be eliminated). That is, a detection error observed in the structure disclosed in patent document 1 and the like, which is attributable to the Early's effect, does not occur. Further, as described above, since the temperature coefficients of the on-resistance values of these transistors are substantially equal, the threshold of a current for detecting the excess current state has small temperature dependency (fluctuation of the threshold due to temperature change is small).

As described above, in the excess current detecting circuit 14 and the power supply device 1 having this excess current detecting circuit 14, excess current detection is possible with much higher accuracy and smaller temperature dependency than those conventional ones, and a detection error (including temperature dependency) thereof is mainly related to relative variation in the on-resistance of the unit cell transistors.

If a detection error in the excess current detection is large, problems as shown below arise in the power supply device 1.

(1) To prevent the breakage or the like of the power MOS transistor 2, the diode 10, and the inductor 11, and the load 6, the maximum output current value Ioₘₐₓ inevitably needs to be set small in view of a detection error. Consequently, although the power MOS transistor 2 and the like are still capable of safe operation, the power MOS transistor 2 is shut off, due to the assumption that the power MOS transistor 2 may turn into an excess current state.

(2) The problem as described above (1) becomes obvious especially when the load 6 is capacitive or a load which pulls a surge current. Forcedly increasing the value for detecting an excess current (that is, the maximum output current value Ioₘₐₓ) increases the likelihood of overload due to a large detection error, thus resulting in deterioration in the reliability of the power MOS transistor 2 and further deterioration in the reliability of the excess current detecting circuit 14 including this power MOS transistor 2 and the reliability of the entire power supply device 1 (higher failure rate).

(3) A large detection error increases the occurrence of a circumstance that the power MOS transistor 2, which is supposed to be shut off, is not shut off. Also in this case, to prevent the breakage of the diode 10 and the like, the diode 10, the inductor 11, and the like of a type having a uselessly large rated current are inevitably used. The use of such types having a large rated current leads to an increase in the packaging surface area and cost increase.

However, in the power supply device 1, due to its capability of excess current detection with very high accuracy and small temperature dependency as described above, the problems as described in the above (1) to (3) are reduced. That is, due to its capability of setting an ideal maximum output current value Ioₘₐₓ reliability improves, thus permitting achieving packaging area reduction and also cost reduction.

(Description of Constant Current Circuit)

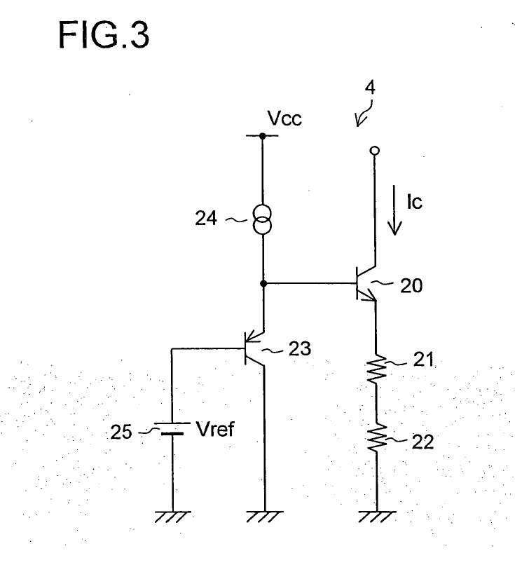

Next, FIG. 3 shows the detailed electric configuration of the constant current circuit 4 in FIG. 1. A reference voltage Vref outputted by a constant voltage generating circuit 25 is connected to the base of a PNP transistor 23, whose emitter is commonly connected to one end of a constant current circuit 24 and the base of a NPN transistor 20. The collector of the transistor 23 is grounded, and a supply voltage Vcc is supplied to the other end of the constant current circuit 24.

The emitter of the transistor 20 is grounded via a series circuit of resitors 21 and 22, and the collector of the transistor 20 is to be connected to the drain electrode of the detection MOS transistor 3. That is, a collector current of the transistor 20 serves as a constant current Ic. With the configuration as in FIG. 3, a value obtained by dividing the reference voltage Vref by a value of combined resistance of the resistances 21 and 22 serves as a value of the constant current Ic.

The resistances 21 and 22 are formed on the semiconductor substrate through diffusion of impurity or the like, upon which, through selection of suitable impurity or the like, the value of the combined resistance of the resistances 21 and 22 becomes fixed without depending on the temperature change.

However, taking a manufacture error or the like into consideration, it is difficult to completely avoid fluctuation of an actual value of combined resistance due to temperature change. Thus, “fixed without depending on temperature change” described here is a concept in a broad sense taking a manufacture error or the like into consideration.

More specifically, for example, the resistance values of the resistances 21 and 22 at the room temperature (for example, 25 C.°) are set at 10 kΩ (kilohm) and 20 kΩ, respectively, and the temperature coefficients of the resistances 21 and 22 are set at +2000 ppm/C.° and −1000 ppm/C.°, respectively.

As described above, the current obtained by adding the reference voltage Vref to the combined resistance of the resistance 21 having the positive temperature coefficient and the resistance 22 having the negative temperature coefficient is provided as the constant current Ic, and the value of the aforementioned combined resistance is fixed without depending on temperature change, whereby the value of the constant current Ic is fixed without depending on temperature change (in a precise sense, “substantially fixed” due to a manufacture error). As a result, the excess current detecting circuit 14 and the power supply device 1 including this can achieve excess current detection with high accuracy and with small temperature dependency.

The resistances 21 and 22 do not necessarily need to be formed on the semiconductor substrate through diffusion of impurity or the like, and thus may be carbon film resistances, metal film resistances, or the like.

(Description of Constant Voltage Generating Circuit 25)

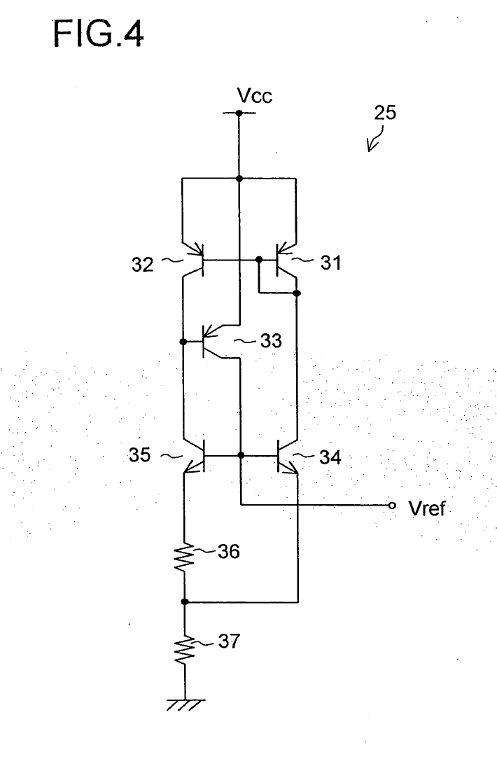

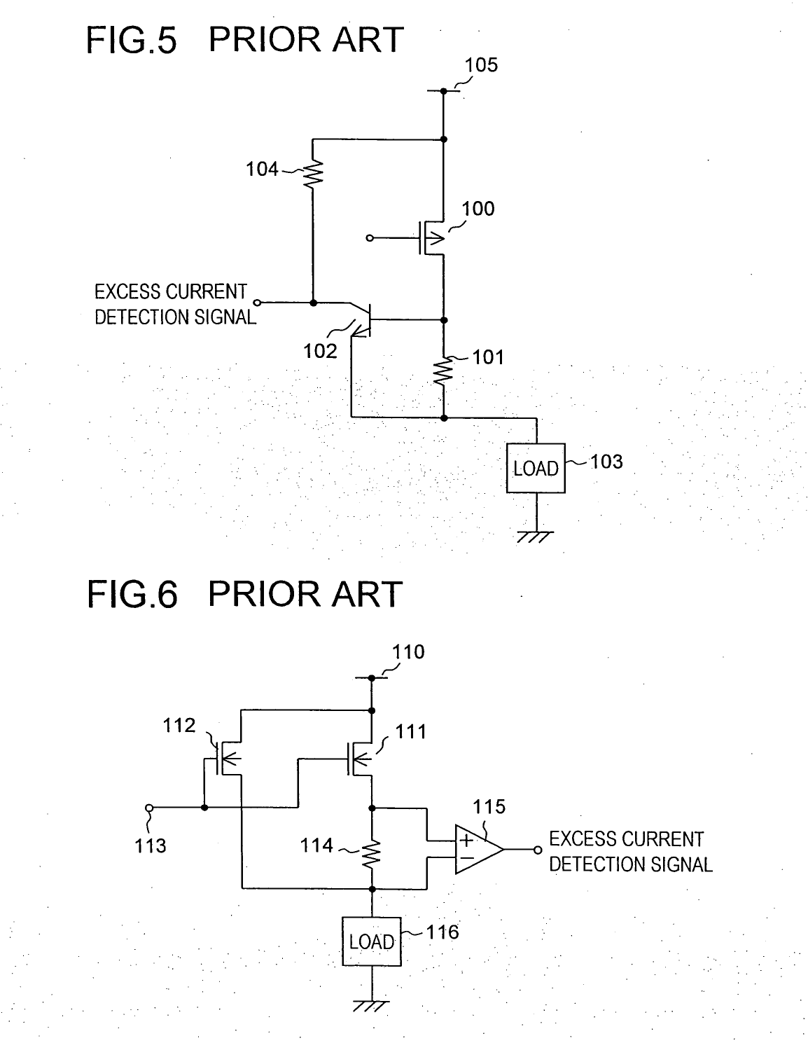

FIG. 4 shows one example of circuit configuration of the constant voltage generating circuit 25. For a PNP transistor 31, the base and the collector are connected together, and a supply voltage Vcc is applied to the emitter. For a PNP transistor 32, the base is connected to the base of the transistor 31, and the supply voltage Vcc is applied to the emitter. For a PNP transistor 33, the base is connected to the collector of the transistor 32, and the supply voltage Vcc is applied to the emitter. For a NPN transistor 34, the base is connected to the collector of the transistor 33, the emitter is grounded via a resistance 37, and the collector is connected to the collector of the transistor 31. For a NPN transistor 35, the base is connected to the collector of the transistor 33, and the emitter is connected to the emitter of the transistor 34 via a resistance 36, and the collector is connected to the collector of the transistor 32. Then, a voltage at a node of the collector of transistor 33, the base of the transistor 34, and the base of the transistor 35 is outputted as a reference voltage Vref.

To reduce the temperature coefficient of this reference voltage Vref, the reference voltage Vref is set with reference to a band gap voltage of the semiconductor (1.205 [V] for silicon). Therefore, the use of such a constant voltage generating circuit 25 for a constant current circuit 4 permits very small temperature dependency of the value of the constant current Ic.

### Modified Embodiment

FIG. 1 shows the embodiment in which the source electrodes of the power MOS transistor 2 and the detection MOS transistor 3 and the gate electrodes thereof are respectively commonly connected together. In this embodiment, added to the inverting input terminal (−) of the comparator 5 is a voltage obtained by subtracting the voltage between the source and drain electrodes of the power MOS transistor 2 from the supply voltage Vcc, and added to the non-inverting input terminal (+) thereof is a voltage obtained by subtracting the voltage between the source and drain electrodes of the detection MOS transistor 3 from the supply voltage Vcc. Providing this configuration eliminates a detection error attributable to the Early's effect.

To eliminate a detection error attributable to the Early's effect, the following can be attempted. Under the condition that the voltage between the gate and source electrodes of the power MOS transistor 2 and the voltage therebetween of the detection MOS transistor 3 are equal, the comparator 5 can compare a voltage V_{DS2} between the source and drain electrodes of the power MOS transistor 2 generated by feeding a current to the load 6 with a voltage V_{DS3} between the source and drain electrodes of the detection MOS transistor 3 generated by feeding the constant current Ic, and can output an excess current detection signal based on a result of this comparison (more specifically, can determine the excess current state when the V_{DS2} becomes larger than the V_{DS3}). Therefore, various modification of the excess current detecting circuit according to the present invention is possible.

The present invention is not limited to the power supply device 1 shown in FIG. 1, and thus is applicable to power supply devices provided with various switching regulators, DC-DC converters, and the like. Further, the present invention is also applicable to power supply devices provided with series regulators (dropper type regulators), such as three-terminal regulators or the like.

(Definition, etc.)

The first electrode, second electrode, and control electrode of the power MOS transistor mentioned in the present invention refer to the source electrode, drain electrode, and gate electrode of the power MOS transistor 2 in FIG. 1. The first electrode, second electrode, and control electrode of the detection MOS transistor mentioned in the present invention refer to the source electrode, drain electrode, and gate electrode of the detection MOS transistor 3 in FIG. 1.

However, modification is possible in which the power MOS transistor 2 and the detection MOS transistor 3 are replaced with N channel MOS transistors, and also modification is possible in which the load 6 is connected to the source side of the power MOS transistor.

Therefore, in the event of such modifications, the first electrode and second electrode of the power MOS transistor mentioned in the present invention may refer to the drain electrode and source electrode, respectively, of the power MOS transistor, and the first electrode and second electrode of the detection MOS transistor mentioned in the present invention may refer to the drain electrode and source electrode, respectively, of the detection MOS transistor.

In the embodiment described above, both the power MOS transistor 2 and the detection MOS transistor 3 are formed of unit cell transistors having the same structure to control the ratio of on-resistance values between the power MOS transistor 2 and the detection MOS transistor 3 (1 to 1000 in the example of the embodiment described above). Alternatively, without use of unit cell transistors, the W/L ratio thereof (where W is a channel width, and L is a channel length) may be appropriately set to control the ratio of on-resistance values between the power MOS transistor 2 and the detection MOS transistor 3.

For example, the power MOS transistor 2 and the detection MOS transistor 3 are manufactured on the semiconductor substrate so as to satisfy W₂/L₂=1000×W₃/L₃ where the channel widths of the power MOS transistor 2 and the detection MOS transistor 3 are W₂ and W₃, respectively, and the channel lengths of the power MOS transistor 2 and the detection MOS transistor 3 are L₂ and L₃, respectively, so that the ratio of on-resistance values between the power MOS transistor 2 and the detection MOS transistor 3 is 1 to 1000.

Moreover, the embodiment described above refers to an example in which the power MOS transistor 2 formed of a MOS transistor is used as an output transistor and the detection MOS transistor 3 formed of a MOS transistor is used as a detection transistor. The power MOS transistor 2 and the detection MOS transistor 3 may be replaced with a PNP output bipolar transistor (output transistor) and a PNP detection bipolar transistor (detection transistor), respectively.

In this case, although the base currents of the bipolar transistors need to be taken into consideration, the same configuration as that of the embodiment described above can be employed. More specifically, in the configuration of FIG. 1, the power MOS transistor 2 is replaced with the output bipolar transistor described above and the source electrode, drain electrode, and gate electrode of the power MOS transistor 2 are replaced with the emitter electrode, collector electrode, and base electrode, respectively, of the output bipolar transistor; the detection MOS transistor 3 is replaced with the detection bipolar transistor described above, and the source electrode, drain electrode, and gate electrode of the detection MOS transistor 3 are replaced with the emitter electrode, collector electrode, and base electrode, respectively, of the detection bipolar transistor.

Here, the output bipolar transistor is formed of a large number of (p-number where p is an integer of 2 or larger) unit cell bipolar transistors, whose collectors, emitters, and bases are respectively connected together in parallel to thereby form a single bipolar transistor, and the detection bipolar transistor is formed of a single unit cell bipolar transistor or formed of a plurality (q-number where q is an integer of 2 or larger which is smaller than p) unit cell bipolar transistors, whose collectors, emitters, and bases are respectively connected together in parallel to thereby from a single bipolar transistor. The unit cell bipolar transistors described above may be all manufactured on the same semiconductor substrate through the same manufacturing processes.

As described above, forming a power supply device by using an output bipolar transistor and a detection bipolar transistor in the same manner as described with reference to FIG. 1 results in achieving excess current detection with a substantially ignorable detection error attributable to the Early's effect.

Instead of forming the output bipolar transistor and detection bipolar transistor described above by using the unit cell bipolar transistors, the driving capability of each of the bipolar transistors may be appropriately set. For example, the output bipolar transistor and the detection bipolar transistor may be manufactured by controlling the emitter areas or the like so that the driving capability of the output bipolar transistor becomes 1000 times that of the detection bipolar transistor.

### INDUSTRIAL APPLICABILITY

The present invention is suitable for a power supply device, a high side switch, and the like, which require an excess current detecting circuit having a small absolute detection error ignoring temperature change and also having small detection error fluctuation dependent on temperature change. The present invention is also suitable for an in-car power supply device which is required to perform excess current detection over a wide range of temperatures (for example, −40 C.° to 125 C.°) with high accuracy.

What is claimed is:

1. An excess current detecting circuit which detects an excess current state of an output transistor for outputting a current to a load and then outputs an excess current detection signal, the excess current detecting circuit comprising:
a detection transistor which is connected to the output transistor in parallel therewith;
a constant current circuit which is connected to one end of the detection transistor and which feeds a predetermined constant current to the detection transistor; and
a comparator which, based on a result of comparison of a voltage between a first and a second electrodes of the output transistor generated by feeding the current to the load and a voltage between a first and a second electrodes of the detection transistor generated by feeding the constant current, outputs the excess current detection signal.

2. An excess current detecting circuit which detects an excess current state of an output transistor for outputting a current to a load via a second electrode thereof and then outputs an excess current detection signal, the excess current detecting circuit comprising:
a detection transistor having a first and a control electrodes commonly connected to a first and a control electrodes, respectively, of the output transistor;
a constant current circuit which is connected to a second electrode of the detection transistor and which feeds a predetermined constant current to the detection transistor; and
a comparator which, based on a result of comparison of a potential of the second electrode of the output transistor and a potential of the second electrode of the detection transistor, outputs the excess current detection signal.

3. An excess current detecting circuit according to claim 1,
wherein the output transistor and the detection transistor are a power MOS transistor and a detection MOS transistor, respectively, and
wherein a value of the constant current is set based on a previously defined maximum output current value of the power MOS transistor, a value of on-resistance of the power MOS transistor, and a value of on-resistance of the detection MOS transistor.

4. An excess current detecting circuit according to claim 1,
wherein the output transistor is a power MOS transistor having n (where n is an integer of two or larger) number of unit cell transistors, and is formed as a single MOS transistor by respectively connecting together drains, sources, and gates of the n-number of unit cell transistors in parallel,
wherein the detection transistor is a detection MOS transistor which is formed of a single unit cell transistor or which has m (where m is an integer of two or larger which is smaller than n) number of unit cell transistors and is formed as a single MOS transistor by respectively connecting together drains, sources, and gates of the m-number of unit cell transistors in parallel, and
wherein the unit cell transistors forming the power MOS transistor and the unit cell transistor or transistors forming the detection MOS transistor are all formed on a same semiconductor substrate by use of a same manufacturing process.

5. The excess current detecting circuit according to claim 1,
wherein the constant current is a current obtained by applying a predetermined reference voltage to combined resistance of resistance having a positive temperature coefficient and resistance having a negative temperature coefficient, and
wherein a value of the combined resistance is adapted to be fixed without depending on temperature change.

6. A power supply device comprising:
the excess current detecting circuit according to claim 1,
the output transistor, and
a smoothing circuit which smoothes an output side voltage of the output transistor and outputs a voltage to the load.

7. The power supply device according to claim 6, further comprising
a voltage detecting circuit which outputs a voltage in accordance with the voltage supplied to the load, and
a control part which, in accordance with an output from the voltage detecting circuit, controls the output transistor and the detection transistor.

8. The power supply device according to claim 7, wherein the control part is controlled in accordance with an output of the comparator.

9. An excess current detecting circuit according to claim 2,
wherein the output transistor and the detection transistor are a power MOS transistor and a detection MOS transistor, respectively, and
wherein a value of the constant current is set based on a previously defined maximum output current value of the power MOS transistor, a value of on-resistance of the power MOS transistor, and a value of on-resistance of the detection MOS transistor.

10. An excess current detecting circuit according to claim 2,
wherein the output transistor is a power MOS transistor having n (where n is an integer of two or larger) number of unit cell transistors, and is formed as a single MOS transistor by respectively connecting together drains, sources, and gates of the n-number of unit cell transistors in parallel,
wherein the detection transistor is a detection MOS transistor which is formed of a single unit cell transistor or which has m (where m is an integer of two or larger which is smaller than n) number of unit cell transistors and is formed as a single MOS transistor by respectively connecting together drains, sources, and gates of the m-number of unit cell transistors in parallel, and
wherein the unit cell transistors forming the power MOS transistor and the unit cell transistor or transistors forming the detection MOS transistor are all formed on a same semiconductor substrate by use of a same manufacturing process.

11. The excess current detecting circuit according to claim 2,
wherein the constant current is a current obtained by applying a predetermined reference voltage to combined resistance of resistance having a positive temperature coefficient and resistance having a negative temperature coefficient, and
wherein a value of the combined resistance is adapted to be fixed without depending on temperature change.

12. A power supply device comprising:
the excess current detecting circuit according to claim 2,
the output transistor, and
a smoothing circuit which smoothes an output side voltage of the output transistor and outputs a voltage to the load.

13. The power supply device according to claim 12, further comprising
a voltage detecting circuit which outputs a voltage in accordance with the voltage supplied to the load, and
a control part which, in accordance with an output from the voltage detecting circuit, controls the output transistor and the detection transistor.

14. The power supply device according to claim 13,
wherein the control part is controlled in accordance with an output of the comparator.
